(19) United States
(12) Patent Application Publication
(10) Pub. No.: US 2009/0014696 A1
(43) Pub. Date: Jan. 15, 2009

(54) LIFTING DEVICE

(76) Inventor: Mark Andrew Stone, Derbyshire (GB)

Correspondence Address: SMITH-HILL AND BEDELL, P.C., 16100 NW CORNELL ROAD, SUITE 220, BEAVERTON, OR, 97006, US

(21) Appl. No.: 11/817,615

(22) PCT Filed: Mar. 3, 2006
(86) PCT No.: PCT/GB06/00755

§ 371 Date: Nov. 13, 2007

(30) Foreign Application Priority Data
Mar. 5, 2005 (GB) 0504621.4

(51) Int. Cl. B66F 3/00; A01G 9/12

(52) U.S. Cl. 254/134; 254/133 A; 47/46

(57) ABSTRACT

A lifting device for positioning an item on a location includes a support which in use applies a lifting force to lift the item, and securing means for securing the item to the support.

The present invention relates to lifting devices, particularly but not exclusively lifting devices for positioning items such as plant containers on locations such as hangers, brackets or the like.

Items such as plant containers are frequently mounted to overhead locations such as brackets mounted on lampposts. The act of installing the plant container is potentially hazardous. Plant containers used in public places can be relatively large and unwieldy. For fixing such containers in an overhead location, a ladder is often used. The use of ladders in public places can be hazardous for members of the public and to traffic, but also members of the public and traffic can be hazardous to users of the ladder. An alternative to the use of a ladder is to use a mobile hydraulic platform. However, such platforms are expensive to hire, and disruptive to traffic flow and/or pedestrians.

U.K. patent application no. 0409971 describes article mounting apparatus for mounting plant containers to lampposts. Such article mounting apparatus requires a user to position a container on a bracket and then move the container to a locked position by a lateral movement of the container. In the locked position the container cannot easily be pushed upwardly off the bracket by, for example, vandals.

According to the present invention, there is provided a lifting device for positioning an item on a location, the device including a support which in use applies a lifting force to lift the item and securing means for securing the item to the support.

Preferably, the securing means are arranged to apply a force to seat the item on the location. Preferably the seating force must be applied to release the item from the support.

Preferably, the securing means include a securing member. Preferably, the securing member is movable relative to the support, and may be movable between a securing position and a release position. Preferably, in use, as the seating force is applied, the seating member is caused to move from the securing position to the release position, and may be caused to so move by a force applied in reaction to the seating force.

Preferably, in the securing position, the item is located between the securing member and the support. Preferably, in the securing position, the securing member is arranged to substantially prevent movement of the item relative to the support.

Preferably, in the release position the item is releasable from the device.

Preferably the device is arranged so that the securing member secures the item to the support while the support applies the lifting force.

Preferably, the lifting force is applied in a first direction, which may be generally upwardly. Preferably, the seating force is applied in a second direction, which may be a different direction to the first direction, and may be generally downwardly. Preferably the seating force when applied causes the item to move laterally, and may cause the item to engage a feature of the location.

Preferably, the device is arranged so that the seating force is applied after the lifting force, and may be applied when the lifting force is no longer being applied.

Preferably, the device includes a mounting for mounting the securing member to the support. Preferably the mounting is telescopic. Preferably in the securing position the telescopic mounting is retracted. Preferably in the release position the telescopic mounting is extended. Preferably, the telescopic mounting includes biasing means, which may bias the securing member to the securing position.

Preferably, the securing member includes a hook. Preferably, the device is arranged to permit operation by a user remote from the support. Preferably, the device includes a handle for gripping by the user. Preferably, the handle extends downwardly from the support.

Preferably, the support includes a frame, which may include a base. Preferably, the frame includes a pair of spaced arms, which may together extend substantially around the item in use. Preferably, a gap is defined between the free ends of the arms. Preferably, the frame includes adjustment means for adjusting the spacing of the arms.

Preferably, the arms are spaced from the base. Preferably the frame includes a spacer for spacing the arms from the base.

Preferably each arm includes a first arm member, and the first arm members may extend outwardly and substantially mutually oppositely from the spacer.

Preferably each arm includes a second arm member, and the second arm members may extend substantially mutually in parallel from the respective first arm members.

Preferably the adjustment means include a plurality of sockets located in the first arm members for receiving the second arm members.

Preferably each arm includes a third arm member, and the third arm members may extend towards each other from the respective second arm members. The gap may be defined between the third arm members. The third arm members may be L-shaped, extending firstly inwardly and then downwardly towards the plane of the base.

Preferably the spacer is a tubular member. Preferably the mounting includes a mounting member, which is receivable within the tubular spacer member to form the telescopic mounting.

Preferably the mounting member mounts the hook.

Preferably, the device includes alignment means for aligning the item on the location.

Preferably, the item is a plant container. Preferably, the location is a bracket or hanger.

Further according to the present invention, there is provided a method of positioning an item on a location, the method including the steps of supporting the item with a lifting device, and applying a lifting force with the lifting device to lift the item, and then applying a seating force with the lifting device to seat the item on the location.

Preferably, the seating force must be applied to release the item from the lifting device. Preferably, the lifting device is in accordance with the lifting device described in the preceding paragraphs. Preferably, the method includes any of the steps or features described in the said preceding paragraphs.

The present invention will now be described, by way of example only and with reference to the accompanying drawings, in which:—

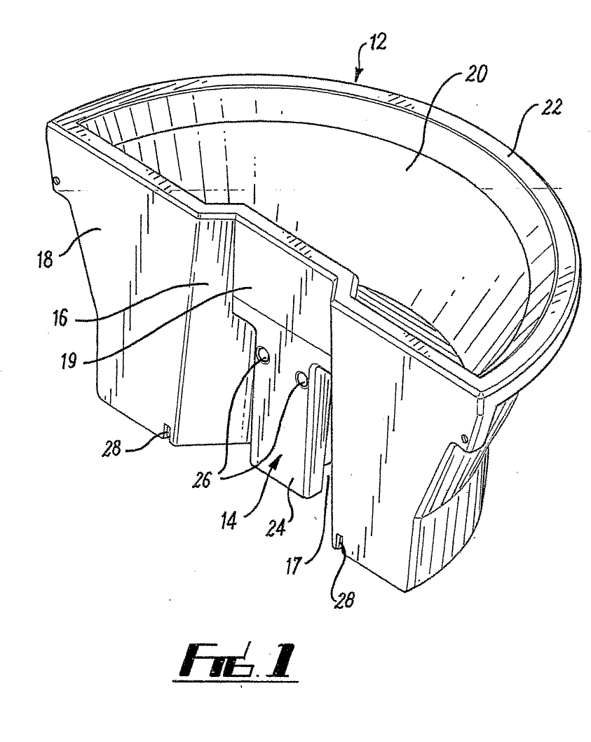

FIG. 1 is a perspective view of a known plant container;

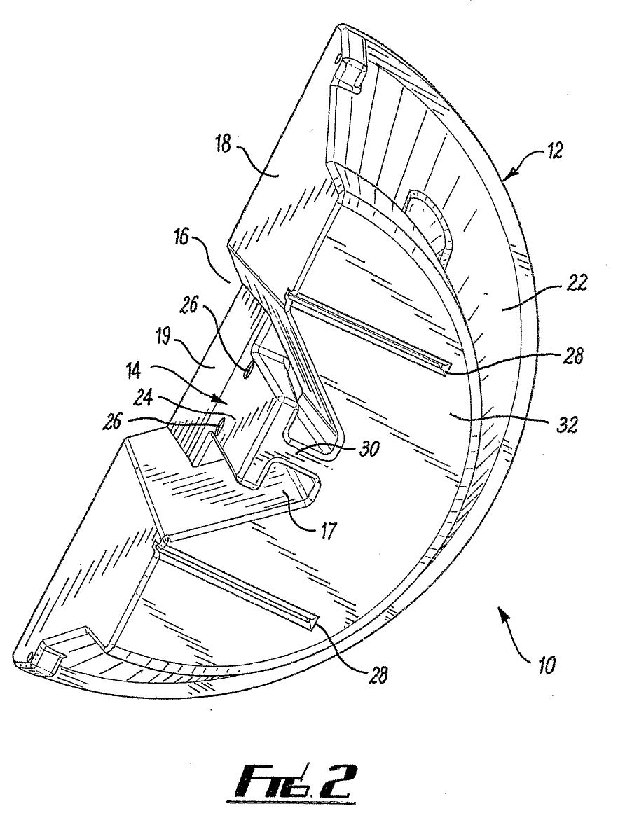

FIG. 2 is another perspective view of the plant container of FIG. 1;

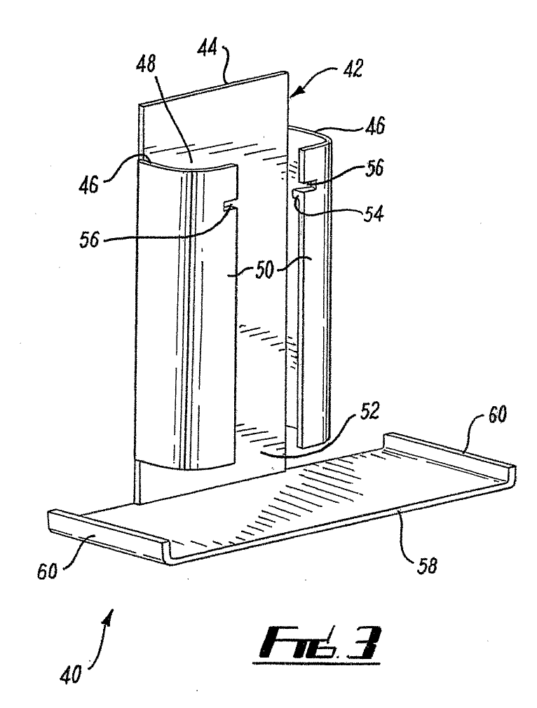

FIG. 3 is a perspective view of a known bracket;

FIG. 4 is a sectional side view of the container of FIGS. 1 and 2 mounted to the bracket of FIG. 3;

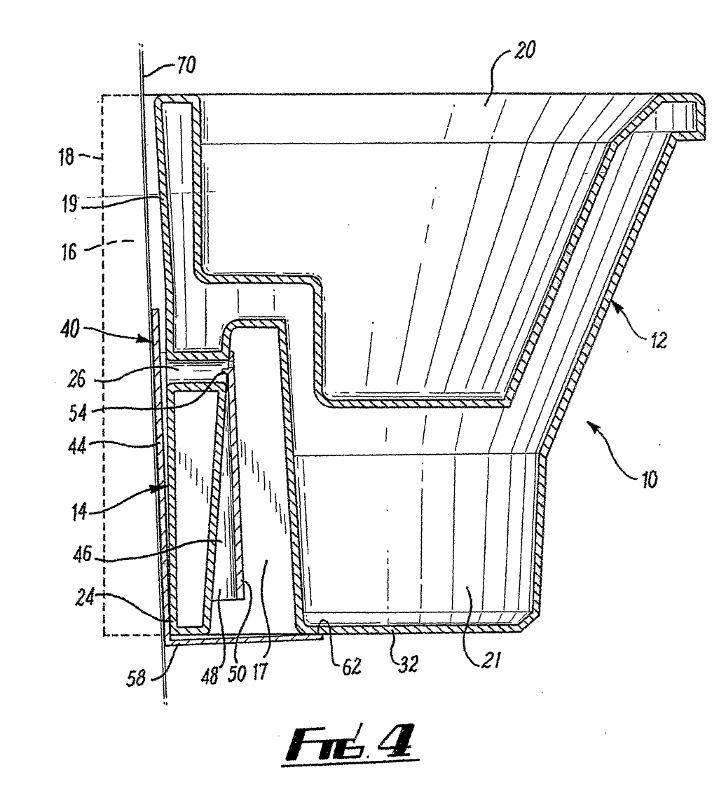

FIG. 5 is a perspective view from the front, one side and above of a lifting device according to the invention;

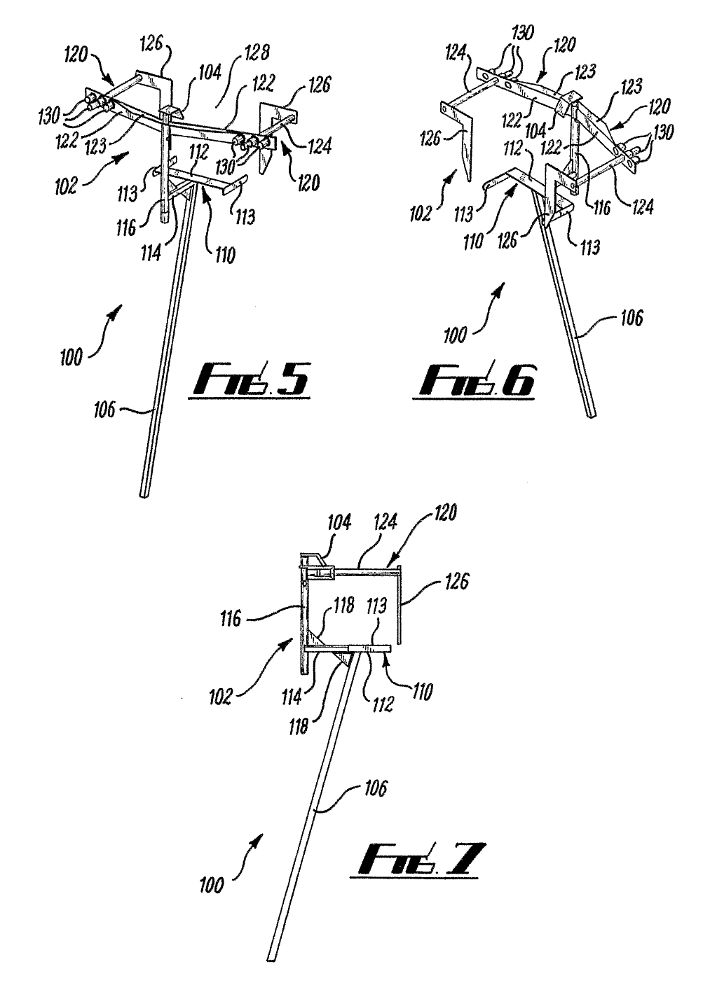

FIG. 6 is a perspective view from the rear, above and the other side of the lifting device of FIG. 5;

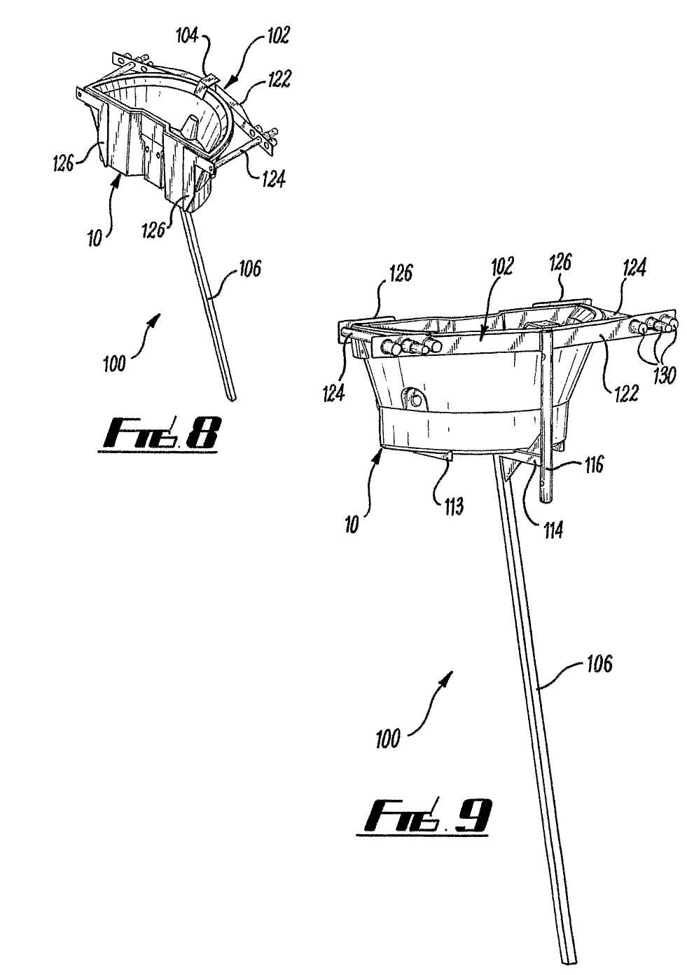

FIG. 7 is a side view of the lifting device of FIGS. 5 and 6;

FIG. 8 is a perspective view from the rear, above and other side of the lifting device and the plant container of FIGS. 1 and 2;

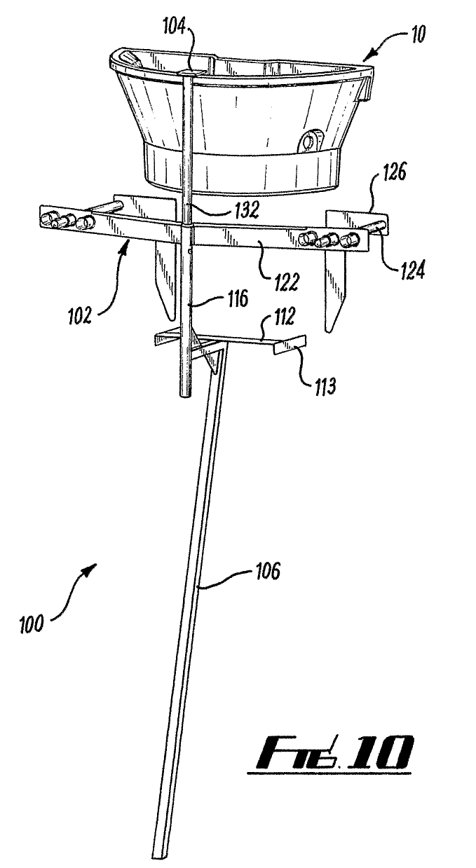

FIG. 9 is a perspective view from the front, one side and above of the lifting device and the container;

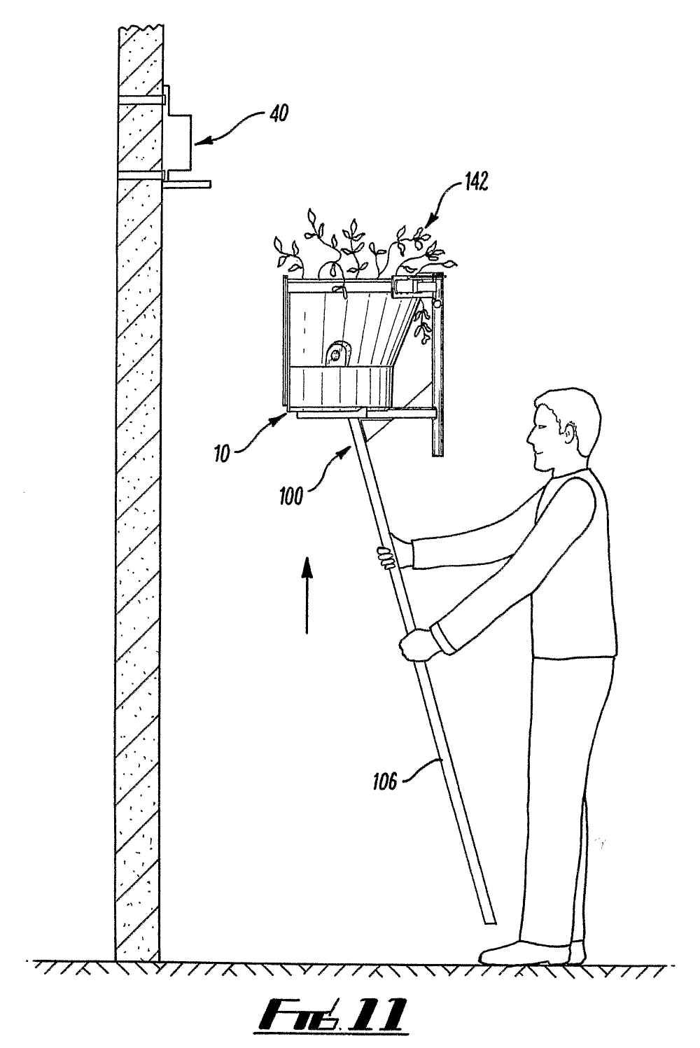

FIG. 10 is a perspective view of the lifting device and container in a release position;

FIG. 11 is a side view of the lifting device, container and bracket in use.

FIGS. 1 to 4 show an example of known article mounting apparatus including a plant container 10 and a post bracket 40, which is the subject of the applicants U.K. patent application no. 0409971.9.

The plant container 10 includes a body 12. The body 12 includes a rear wall 18, a semi-circular front wall 22 and a base 32, which together define an interior 20. Each wall 18, 22, 32 is double skinned, defining an enclosed cavity therebetween, a lower part of which cavity forms a water reservoir 21. Such containers are commonly called “self watering containers”. Such containers include filling means in the form of a filling aperture (not shown) defined in the outer skin of the semi circular front wall 22 to allow filling and replenishment of the water in the water reservoir 21. In use, the interior 20 is filled with plant compost and plant material, and a capillary means such as capillary matting is provided between the water reservoir 21 and the interior 20 to allow the plants planted in the interior 20 to draw up water from the water reservoir 21.

The container 10 is formed of plastics material, and more particularly is formed of polyethylene, and is formed by rotational moulding.

The rear wall 18 includes a recess 16. The in use upper part of the recess 16 is relatively shallow having an upper recess rear wall 19. The lower part 17 of the recess 16 is deeper than the upper part, extending further into the container 10.

The container 10 includes a container bracket 14 which includes an engaging projection 24 extending downwardly from the upper recess rear wall 19 into the deeper recess 17. A web 30 extends from the engaging projection 24 to the rear wall 18 in the deeper recess 17. As shown most clearly in FIG. 2, the engaging projection 24 and the web 30 form a T shape when viewed from below.

As shown most clearly in FIGS. 2 and 4, the engaging projection tapers inwardly downwardly from the upper recess rear wall 19.

The engaging projection 24 defines a pair of parallel through passages 26 which extend from front to rear of the engaging projection 24 and are located in the upper part of the engaging projection 24.

The base 32 defines a pair of parallel channels 28 which extend from the rear wall 18 close to, the recess 16, with one channel on either side of the recess 16. The channels 28 extend substantially across most of the width of the base 32.

FIG. 3 shows a post bracket 40 having a body 42, the body 42 including a mounting member 44 in the form of a generally rectangular planar plate. A pair of spaced, substantially parallel side members 46 extend forwardly from the plate 44. Each side member 46 includes a lip 50, each lip 50 extending inwardly towards the other lip 50 of the other side member 46. Together, the mounting member 44, the side members 46 and the lips 50 define a channel 48. A mouth 52 is defined between the lips 50.

Each lip 50 includes a locking projection in the form of a lug 54 which extends backwardly into the channel 48. The lugs 54 are located towards the upper end of the lips 50 in use.

A generally rectangular planar support member 58 extends substantially horizontally in use and forwardly from a lower edge of the mounting member 44. The support member 58 extends outwardly on either side of the mounting member 44. At each side edge of the support member 58, the support member 58 extends upwardly to form a rim 60.

The post bracket 40 is fabricated from steel. The lugs 54 are formed by cutting and bending of the lips 50, which forming process results in the formed apertures 56. After fabrication, the post bracket 40 is finished with a suitable protective coating.

FIG. 4 shows the apparatus in use. The post bracket 40 is mounted by conventional means to a ground engaging support member in the form of a lamppost 70, so that the plane of the mounting member 44 is substantially vertical, and the plane of the support member 58 is substantially horizontal. The plant container 10 is located over the post bracket 40 and moved in a substantially vertical downward direction so that the engaging projection 24 is received in the channel 48. Movement continues until the container 10 locates on the support member 58. In this position, the engaged position, the engaging projection 24 is engaged within the bracket 40 and the web 30 extends through the mouth 52, but the lugs 54 are not within the passages 26.

The container 10 is then pivoted about a pivot point 62 which is located on the support member 58. The container 10 pivots forwardly and downwardly so that the upper part of the engaging projection 24 moves forwardly within the channel 48 to a locked position in which the passages 26 receive the lugs 54, as shown in FIG. 4.

In the locked position, each lug 54 is received in the corresponding passage 26 so that if an attempt is made to move the container 10 vertically upwards to dislodge the container 10 from the post bracket 40, the location of the lugs 54 in the passages 26 prevents the upward movement.

The taper of the engaging projection 24 allows ease of manufacture, and also aids location of the engaging projection 24 in the channel 48. The engaging projection 24 is arranged to fit within the channel 48 so that only a relatively small pivotal movement of the container 10 is required to engage the lugs within the passages 26.

As the engaging projection 24 locates within the channel 48, the upturned rims 60 of the support member 58 locate in the channels 28 of the base 32 of the container 10.

FIGS. 5-11 show an example of a lifting device 100 in accordance with the present invention. FIGS. 5-7 show the lifting device 100 in an empty condition. The lifting device 100 includes a support in the form of a frame 102, securing means including a securing member in the form of a hook 104, and a handle 106. The frame 102 includes a base 110, the base 110 comprising a substantially planar base plate 112. Generally in use, the plane of the base plate 112 is substantially horizontal.

The handle 106 extends downwardly from the base plate 112. When viewed from the side, as shown in FIG. 7, the handle 106 extends downwardly at an angle to the plane of the base plate 112 of between 70 and 80°. The base 110 includes a pair of spaced substantially parallel rails 113 which extend rearwardly and horizontally in use from each of the side ends of the base plate 112. The base 110 includes a base bar member 114 which extends forwardly and substantially horizontally from the junction between the handle 106 and the base plate 112.

The frame 102 includes a spacer in the form of a substantially upright tubular support member 116, which extends from the forward end of the base bar member 114. The frame 102 further includes a pair of spaced arms 120 which extend outwardly and rearwardly from the upright support member 116. The support member 116 spaces the arms 120 from the base plate 112. Each of the arms 120 includes a front arm member 122 which extends outwardly from the support member 116 and substantially mutually oppositely from the other front arm member 122, a side arm member 124 extending rearwardly from each of the front arm members 122 and substantially mutually in parallel with the other side arm member 124, and a rear arm member 126 extending inwardly from each of the side arm members 124 towards the other rear arm member 126. A lip 123 extends forwardly from a portion of the upper edge of each of the front arm members 122, the lips 123 providing additional strength and rigidity.

The rear arm members 126 are L-shaped, extending firstly inwardly from the side arm members 124 and then downwardly towards the plane of the base plate 112. The rear arm members 126 define a gap 128 therebetween. The front arm members 122, side arm members 124 and the inwardly extending parts of the rear arm members 126 are substantially coplanar, and parallel with the plane of the base plate 112.

Triangular bracing fillets 118 are provided between the handle 106 and the base bar 114, and between the base bar 114 and the upright support member 116. The bracing fillets 118 provide additional rigidity and strength.

The lifting device 100 includes adjustment means in the form of a plurality of sockets 130 located at the outer ends of the front arm members 122. The sockets 130 receive the side arm members 124. In the example shown in FIGS. 5-7, three sockets 130 are provided at each end of the front arm members 122, and each side arm member 124 is positioned within the middle of the three sockets 130. Each socket 130 includes a pair of opposed apertures (not shown) and each of the side arm members 124 includes a passage (not shown). In an assembled condition, a pin (not shown) extends through the apertures of the sockets 130 and the passage of the side arm member 124, to lock the side arm member 124 in position in the socket 130. The side arm members 124 can be readily repositioned in any of the sockets 130 to accommodate different size containers. Each of the side arm members 124 could also include a plurality of spaced passages, to accommodate containers having different dimensions front to back.

The hook 104 is mounted on a hook mounting member 132, as shown most clearly in FIG. 10. The hook mounting member 132 is slidably received within the tubular upright support member 116, thus providing a telescopic mounting for the hook 104. The hook 104 is movable between a securing position in which the hook mounting 132 member is substantially retracted within the upright support member 116, and a release position, in which the hook mounting member 132 is fully extended from the upright support member 116. A stop (not shown) is provided to limit the extension of the hook mounting member 132.

The lifting device 100 can be easily fabricated by conventional methods from standard mild steel stock and finished by powder coating, galvanising and/or painting. Alternatively, any other suitable material, joining methods and finish could be used.

FIGS. 8-11 show the lifting device 100 in use. In the example shown in these figures, the item is the plant container 10 as described in U.K. patent application no. 0409971 and in FIGS. 1-4 above. Initially, the base 32 of the container 10 is positioned on the base plate 112 of the lifting device 100 between the arms 120. To position the container 10 on the lifting device 100, the hook mounting member 132 must be extended to the release position. With the container 10 in position on the base plate 112, the hook mounting member 132 is then retracted into the upright support member 116, so that the hook 104 hooks over the front wall 22 of the container 10 and into the interior 20 of the container 10, as shown in FIGS. 8 and 9. The side arm members 124 can be repositioned in the sockets 130 as required to accommodate the container 10.

As shown in FIG. 11, in use the container 10 may be filled with material such as potting compost and plants 142, but without water in the reservoir 21 to reduce the weight to be lifted. The user grips the handle 106 and lifts the container 10 upwardly towards the bracket 40 thus applying a lifting force to the container 10 through the frame 102.

During lifting, the frame 102 provides support underneath and at the front and back for the container 10, ensuring a safe and secure lift. The hook 104 secures the container 10 to the frame 104, substantially preventing movement of the container 10 relative to the frame 102, and in particular substantially preventing an upward movement of the container 10 relative to the frame 102.

The user manipulates the lifting device 100 so that the engaging projection 24 of the container bracket 14 locates within the channel 48 of the bracket 40, as described above. To release the container 10 from the lifting device 100, the user then exerts a pulling or seating force downwardly via the handle 106, so that the hook mounting member 132 is extended from the upright support member 116 by the reaction force applied by the container 10 to the hook 104. The frame 102 moves downwardly and can then be moved forwardly clear of the container 10. The gap 128 between the rear arm members 126 is sized to permit the widest part of the bracket 40 to pass therethrough. Once the frame 102 is clear of the container 10, the lifting device 100 can then be moved upwardly to disengage the hook 104 from the container wall 22.

As the user pulls downwardly on the handle 106 to extend the hook support member 132, the container 10 is caused to pivot laterally forwardly and downwardly to the locked position, in which the passages 26 receive the lugs 54. Thus the operation of the lifting device 100 causes the plant container 10 to be seated on the location in the locked position.

The hook mounting member 132 could be arranged to retract back into the upright support member 116 when the lifting device 100 is in a generally upright position, the force of gravity providing a biasing means to bias the hook 104 to the securing position. Alternatively, the hook mounting member 132 could be lubricated, and could require a force provided by a user to move the hook 104 to the securing position. As a further alternative, a biasing means such as a spring could be provided to bias the hook 104 to the securing position.

The rails 118 are equally spaced from the handle 106 and correspond with the upturned rims 60 of the bracket 40. The user, looking from the front and below at the underneath of the bracket 40 and device 100, can thus align the container 10 to the bracket 40 by aligning the rails 113 with the rims 60, the rails 113 thus providing alignment means.

The angle of the handle 106 to the base plate 112 enables the user when lifting and positioning the container to be standing forwardly of the container, providing a better view and a safer securing position should material fall from the container 10 or bracket 40. The handle 106 could be between 1.5 and 2.5 m long.

Various other modifications may be made without departing from the scope of the invention. The orientation of the support relative to the handle could be different. The arrangement of the support could be different. The mounting of the hook could be different. The arrangement of the hook relative to the support may be different, and a plurality of hooks may be provided.

There is thus provided a lifting device which permits the positioning of an item such as a plant container on an overhead location such a as bracket mounted on a lamppost without requiring the user to leave the ground by means of, for instance, a ladder or hydraulically powered lifting platform. The lifting device enables the positioning of the container accurately and quickly, with minimal disruption to traffic or other street, road or pathway users. The movable hook is arranged to ensure that the container is correctly seated on the bracket, and when used in combination with the article mounting apparatus of GB0409971, the lifting device ensures that the container is mounted in the locked position. The lifting device is relatively simple and light, and does not require a power supply.

Although the device has been described by reference to the article mounting apparatus of GB0409971, the device of the invention could be used for lifting any suitable item on to any suitable location, and particularly where a force is required to seat the item on the location or to ensure the item is seated on the location. The device provides the advantage that the item cannot be released from the device without the seating force being applied, so ensuring that the item is securely seated on the location even if the device is being used by an untrained, unsupervised or inexperienced user.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1-38. (canceled)

39. A lifting device for positioning an item on a location, the device including a support which in use applies a lifting force to lift the item and securing means for securing the item to the support.

40. A lifting device according to claim 39, in which the securing means are arranged to apply a force to seat the item on the location.

41. A lifting device according to claim 39, in which the securing means are arranged to apply a force to seat the item on the location, and the seating force must be applied to release the item from the support.

42. A lifting device according to claim 39, in which the securing means include a securing member.

43. A lifting device according to claim 39, in which the securing means include a securing member, and the securing member is movable relative to the support between a securing position and a release position.

44. A lifting device according to claim 39, in which the securing means are arranged to apply a force to seat the item on the location and include a securing member, in use, and as the seating force is applied, the securing member is caused to move from a securing position to a release position by a force applied in reaction to the seating force.

45. A lifting device according to claim 39, in which the securing means include a securing member, and in a securing position, the item is located between the securing member and the support, and the securing member is arranged to substantially prevent movement of the item relative to the support.

46. A lifting device according to claim 39, in which the securing means include a securing member, and the device is arranged so that the securing member secures the item to the support while the support applies the lifting force.

47. A lifting device according to claim 39, in which the lifting force is applied in a first direction, which is generally upwardly.

48. A lifting device according to claim 39, in which the securing means are arranged to apply a force to seat the item on the location, and the seating force is applied in a second direction which is generally downwardly.

49. A lifting device according to claim 39, in which the securing means are arranged to apply a force to seat the item on the location, and the seating force when applied causes the item to move laterally to engage a feature of the location.

50. A lifting device according to claim 39, in which the securing means are arranged to apply a force to seat the item on the location, and the device is arranged so that the seating force is applied after the lifting force.

51. A lifting device according to claim 39, in which the securing means are arranged to apply a force to seat the item on the location, and the device is arranged so that the seating force is applied when the lifting force is no longer being applied.

52. A lifting device according to claim 39, in which the securing means include a securing member, and the device includes a mounting for mounting the securing member to the support.

53. A lifting device according to claim 39, in which the securing means include a securing member, and the device includes a mounting for mounting the securing member to the support, and the mounting is telescopic.

54. A lifting device according to claim 39, in which the securing means include a securing member, and the device includes a mounting for mounting the securing member to the support, and the mounting is telescopic, and in a securing position the telescopic mounting is retracted and in a release position the telescopic mounting is extended.

55. A lifting device according to claim 39, in which the mounting is telescopic in a securing position the telescopic mounting is retracted and in a release position the telescopic mounting is extended, and the telescopic mounting includes biasing means, which bias the securing member to the securing position.

56. A lifting device according to claim 39, in which the securing means include a securing member, and the securing member includes a hook.

57. A lifting device according to claim 39, in which the device includes a handle for gripping by the user, which handle extends downwardly from the support.

58. A lifting device according to claim 39, in which the support includes a frame, which includes a base and a pair of spaced arms, the arms together extending substantially around the item in use, a gap being defined between the free ends of the arms.

59. A lifting device according to claim 39, in which the support includes a frame, and the frame includes adjustment means for adjusting the spacing of the arms.

60. A lifting device according to claim 39, in which the support includes a frame, which includes a base and a pair of spaced arms, the arms together extending substantially around the item in use, a gap being defined between the free ends of the arms, and the frame includes a spacer for spacing the arms from the base.

61. A lifting device according to claim 39, in which the device includes alignment means for aligning the item on the location.

62. A lifting device according to claim 39, in which the item is a plant container and the location is a bracket or hanger.

63. A method of positioning an item on a location, the method including the steps of supporting the item with a lifting device, and applying a lifting force with the lifting device to lift the item, and then applying a seating force with the lifting device to seat the item on the location.

64. A method according to claim 63, in which the seating force must be applied to release the item from the lifting device.

65. A method according to claim 63, in which the lifting device includes a support which in use applies a lifting force to lift the item and securing means for securing the item to the support.
